(19) United States
(12) Patent Application Publication
(10) Pub. No.: US 2025/0244172 A1
(43) Pub. Date: Jul. 31, 2025

(54) SPECTROMETRY DEVICE

(71) Applicant: HAMAMATSU PHOTONICS K.K., Hamamatsu-shi, Shizuoka (JP)

(72) Inventors: Kenichi OHTSUKA, Hamamatsu-shi, Shizuoka (JP); Hideki MASUOKA, Hamamatsu-shi, Shizuoka (JP); Kazuya IGUCHI, Hamamatsu-shi, Shizuoka (JP); Ikuo ARATA, Hamamatsu-shi, Shizuoka (JP)

(73) Assignee: HAMAMATSU PHOTONICS K.K., Hamamatsu-shi, Shizuoka (JP)

(21) Appl. No.: 18/855,082

(22) PCT Filed: Dec. 19, 2022
(86) PCT No.: PCT/JP2022/046725

§ 371 Date: Oct. 8, 2024

(30) Foreign Application Priority Data
May 27, 2022 (JP) 2022-086930

(51) Int. Cl. G01J 3/28; G01J 3/02; G01J 3/18

(52) U.S. Cl. CPC G01J 3/2803; G01J 3/0208; G01J 3/0262; G01J 3/0278; G01J 3/18

(57) ABSTRACT

The spectroscopic measurement device includes a light entrance portion, a reflective diffraction grating, an optical detector, a lens, and an analyzer. The optical detector outputs first spectral data of light to be measured by receiving a spectral image in a first exposure time in a first light receiving region, and outputs second spectral data of the light to be measured by receiving the spectral image in a second exposure time longer than the first exposure time in a second light receiving region arranged side by side with the first light receiving region. The analyzer generates spectral data based on the first spectral data and the second spectral data. The optical detector is disposed so that a stray light region, in which stray light gathers, is located in the first light receiving region.

### TECHNICAL FIELD

The present disclosure relates to a spectroscopic measurement device.

### BACKGROUND ART

There has been a known spectroscopic measurement device including a light entrance portion that allows light to be measured to be incident thereon, a reflective diffraction grating that disperses light to be measured incident from the light entrance portion, an optical detector that detects light to be measured dispersed by the reflective diffraction grating, and a lens that guides light to be measured incident from the light entrance portion to the reflective diffraction grating and forms a spectral image of light to be measured, which is dispersed by the reflective diffraction grating, in a light receiving region of the optical detector (for example, see Patent Literature 1). A spectroscopic measurement device that employs such an optical system (referred to as a Dyson optical system) has an advantage of improving wavelength resolution in measurement of light to be measured.

On the other hand, the spectroscopic measurement device employing the Dyson optical system has a disadvantage that stray light is easily generated, and when no measures are taken, detection accuracy is likely to decrease in measurement of light to be measured. For example, in the spectroscopic measurement device using the Dyson optical system, a stray light region (a region where stray light gathers) is likely to appear due to multiple reflections of a part of light to be measured in the lens. As a countermeasure therefor, it is conceivable to increase a distance between the light entrance portion and the optical detector so that the stray light region is not located in the light receiving region of the optical detector.

### CITATION LIST

### Patent Literature

Patent Literature 1: Specification of US Patent Application Publication No. 2009/0237657

### SUMMARY OF INVENTION

### Technical Problem

However, when the distance between the light entrance portion and the optical detector is increased, aberration generated by the lens increases, and as a result there is concern about a decrease in wavelength resolution in measurement of light to be measured.

An object of the disclosure is to provide a spectroscopic measurement device capable of suppressing both a decrease in wavelength resolution and a decrease in detection accuracy in measurement of light to be measured.

### Solution to Problem

A spectroscopic measurement device of an aspect of the disclosure is [1]“a spectroscopic measurement device including a light entrance portion allowing light to be measured to be incident thereon, a reflective diffraction grating configured to disperse the light to be measured incident from the light entrance portion, an optical detector configured to detect the light to be measured dispersed by the reflective diffraction grating, a lens configured to guide the light to be measured incident from the light entrance portion to the reflective diffraction grating and to form a spectral image of the light to be measured dispersed by the reflective diffraction grating on a light receiving region of the optical detector, and an analyzer configured to generate spectral data of the light to be measured, wherein the light receiving region includes a first light receiving region including a plurality of first light detection channels arranged in a direction parallel to a wavelength axis of the spectral image, and a second light receiving region arranged side by side with the first light receiving region in a direction perpendicular to the wavelength axis, and including a plurality of second light detection channels arranged in the direction parallel to the wavelength axis, the optical detector outputs first spectral data of the light to be measured by receiving the spectral image in a first exposure time in the first light receiving region, and outputs second spectral data of the light to be measured by receiving the spectral image in a second exposure time longer than the first exposure time in the second light receiving region, the analyzer generates the spectral data based on the first spectral data and the second spectral data output from the optical detector, and the optical detector is disposed so that a stray light region, in which stray light generated in an optical path from the light entrance portion to the optical detector gathers, is located in the first light receiving region”.

In the spectroscopic measurement device described in [1], the light receiving region of the optical detector has the first light receiving region and the second light receiving region arranged side by side in the direction perpendicular to the wavelength axis of the spectral image, and the optical detector is disposed so that the stray light region, in which the stray light generated in the optical path from the light entrance portion to the optical detector gathers, is located in the first light receiving region. In this way, when compared to the case where a distance between the light entrance portion and the optical detector is increased so that the stray light region is not located in the light receiving region of the optical detector, aberration generated by the lens can be reduced, thereby suppressing a reduction in wavelength resolution in measurement of the light to be measured. Further, in the spectroscopic measurement device described in [1], the optical detector outputs the first spectral data of the light to be measured by receiving the spectral image in the first exposure time in the first light receiving region and outputs the second spectral data of the light to be measured by receiving the spectral image in the second exposure time longer than the first exposure time in the second light receiving region, and the analyzer generates the spectral data of the light to be measured based on the first spectral data and the second spectral data. In this way, by using the first spectral data for a wavelength band in which light intensity is high and using the second spectral data for a wavelength band in which light intensity is low while offsetting the wavelength band corresponding to the stray light region from a wavelength band where light intensity is high in generating the spectral data of the light to be measured, it is possible to suppress a decrease in detection accuracy in measurement of the light to be measured. As described above, according to the spectroscopic measurement device described in [1], it is possible to suppress both a decrease in wavelength resolution and a decrease in detection accuracy in measurement of the light to be measured.

A spectroscopic measurement device of an aspect of the disclosure may be [2]“the spectroscopic measurement device according to [1], wherein the analyzer generates the spectral data based on data in a wavelength band not including a wavelength band corresponding to the stray light region in the first spectral data and data in a wavelength band including the wavelength band corresponding to the stray light region in the second spectral data”. In the spectroscopic measurement device described in [2], the stray light is detected in the wavelength band corresponding to the stray light region in the first spectral data. On the other hand, the stray light is not detected in the wavelength band corresponding to the stray light region in the second spectral data. Therefore, according to the spectroscopic measurement device described in [2], a decrease in detection accuracy in measurement of the light to be measured can be suppressed by complementing data in an excluded wavelength band using second spectral data while eliminating an influence of the stray light from the first spectral data.

A spectroscopic measurement device of an aspect of the disclosure may be [3]“the spectroscopic measurement device according to [1] or [2], wherein the optical detector is offset to one side in the direction perpendicular to the wavelength axis with respect to the light entrance portion”. According to the spectroscopic measurement device described in [3], it is possible to easily and reliably realize arrangement of the optical detector for positioning the stray light region in the first light receiving region.

A spectroscopic measurement device of an aspect of the disclosure may be [4]“the spectroscopic measurement device according to any one of [1] to [3], wherein the stray light is generated by multiple reflections of a part of the light to be measured inside the lens”. The dominant cause of appearance of the stray light region is multiple reflections of a part of the light to be measured inside the lens. According to the spectroscopic measurement device described in [4], it is possible to further suppress a decrease in detection accuracy in measurement of the light to be measured by eliminating the influence of the stray light region.

A spectroscopic measurement device of an aspect of the disclosure may be [5]“the spectroscopic measurement device according to any one of [1] to [4], further including a mask member disposed between the lens and the optical detector and configured to block the stray light”. According to the spectroscopic measurement device described in [5], it is possible to eliminate the influence of the stray light region by blocking incidence of the stray light on the optical detector. Therefore, it is possible to further suppress the decrease in detection accuracy in measurement of the light to be measured.

A spectroscopic measurement device of an aspect of the disclosure may be [6]“the spectroscopic measurement device according to any one of [1] to [5], wherein the lens is a convex lens having a surface facing the light entrance portion and the optical detector, and a convex surface facing the reflective diffraction grating”. According to the spectroscopic measurement device described in [6], it is possible to guide the light to be measured incident from the light entrance portion to the reflective diffraction grating, and to form the spectral image of the light to be measured dispersed by the reflective diffraction grating in the light receiving region of the optical detector.

### Advantageous Effects of Invention

According to the disclosure, it is possible to provide a spectroscopic measurement device capable of suppressing both a decrease in wavelength resolution and a decrease in detection accuracy in measurement of light to be measured.

### BRIEF DESCRIPTION OF DRAWINGS

FIG. 1 is a diagram illustrating a configuration of a spectroscopic measurement device of an embodiment.

FIG. 2 is a diagram illustrating a configuration of an optical detector illustrated in FIG. 1.

FIG. 3 is a diagram illustrating first spectral data and second spectral data.

FIG. 4 is a diagram illustrating spectral data of light to be measured.

FIG. 5 is a diagram illustrating a configuration of an optical detector of a first modified example.

FIG. 6 is a diagram illustrating a configuration of an optical detector of a second modified example and spectral data of light to be measured.

### DESCRIPTION OF EMBODIMENTS

Hereinafter, embodiments of the disclosure will be described in detail with reference to the drawings. Note that, in each drawing, the same or corresponding parts are denoted by the same reference numerals, and duplicated description will be omitted.

### [Configuration of Spectroscopic Measurement Device]

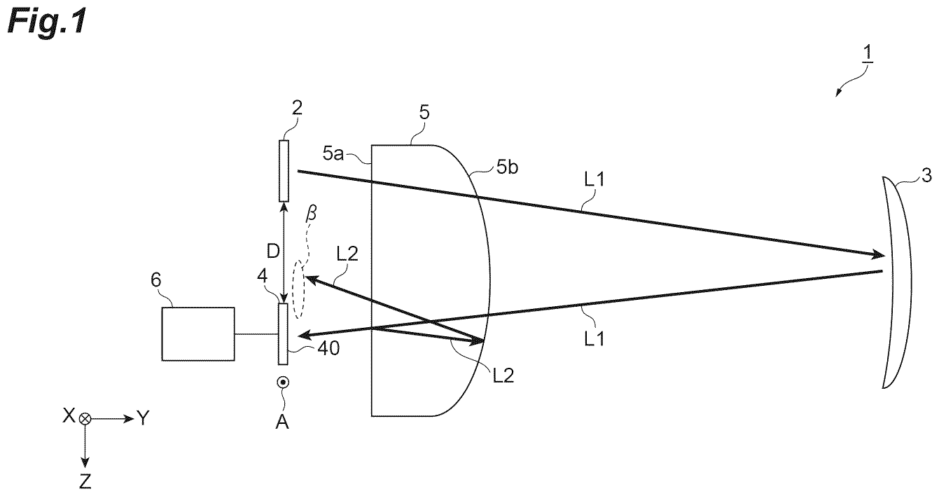

As illustrated in FIG. 1, a spectroscopic measurement device 1 includes a light entrance portion 2, a reflective diffraction grating 3, an optical detector 4, a lens 5, and an analyzer 6. The spectroscopic measurement device 1 is a device that generates spectral data of light to be measured L1 by dispersing the light to be measured L1.

The light entrance portion 2, the reflective diffraction grating 3, and the lens 5 are included in an optical system (so-called Dyson optical system) for guiding the light to be measured L1 to a light receiving region 40 of the optical detector 4 and forming a spectral image α of the light to be measured L1 on the light receiving region 40 of the optical detector 4 along a wavelength axis A. The light to be measured L1 is dispersed by the reflective diffraction grating 3 in a direction perpendicular to a direction in which the light to be measured L1 is incident. Here, a direction in which the light to be measured L1 is dispersed (that is, a direction parallel to the wavelength axis A) is referred to as an X-axis direction, a direction perpendicular to the X-axis direction is referred to as a Y-axis direction, and a direction perpendicular to the X-axis direction and the Y-axis direction is referred to as a Z-axis direction.

The light entrance portion 2 is disposed to allow the light to be measured L1 to be incident on the inside of the spectroscopic measurement device 1. The light entrance portion 2 adjusts the amount of incidence of the light to be measured L1. The light entrance portion 2 is, for example, a slit member. When viewed from the Y-axis direction, a slit formed in the slit member opens in a rectangular shape with a short side in the X-axis direction and a long side in the Z-axis direction. When a width of the short side is increased, the amount of incidence of the light to be measured L1 increases, and thus spectral data having less noise and low wavelength resolution is obtained in the analyzer 6. On the other hand, when the width of the short side is decreased, the amount of incidence of the light to be measured L1 decreases, and thus spectral data having improved wavelength resolution and a lot of noise is obtained in the analyzer 6. For example, the light entrance portion 2 may include a slit member and an optical fiber that transmits the light to be measured L1 to the slit member. Alternatively, for example, the light entrance portion 2 may include a slit member and a lens that collects the light to be measured L1 from the outside of the slit member.

The reflective diffraction grating 3 faces the light entrance portion 2 in the Y-axis direction. The reflective diffraction grating 3 disperses the light to be measured L1 in a direction opposite to the direction in which the light to be measured L1 is incident. The reflective diffraction grating 3 includes a plurality of grating grooves (not illustrated). The plurality of grating grooves extends along the Z-axis direction, which is a direction perpendicular to the alignment direction, while being aligned along the X-axis direction, which is a direction perpendicular to the direction in which the light to be measured L1 is incident. The light to be measured L1 incident on the reflective diffraction grating 3 is dispersed according to a wavelength along the X-axis direction, which is a direction in which the plurality of grating grooves is aligned.

The optical detector 4 faces the reflective diffraction grating 3 in the Y-axis direction. In the present embodiment, an arrangement position of the optical detector 4 coincides with that of the light entrance portion 2 in the Y-axis direction. The optical detector 4 is disposed on a side where the dispersed light to be measured L1 is incident, with a certain distance D between the optical detector 4 and the light entrance portion 2 in the Z-axis direction. In other words, with respect to the light entrance portion 2, the optical detector 4 is offset to the side where the dispersed light to be measured L1 is incident along a direction perpendicular to the wavelength axis A (Z-axis direction). The optical detector 4 detects the light to be measured L1 dispersed by the reflective diffraction grating 3. In the present embodiment, the optical detector 4 is a CCD image sensor formed on a semiconductor substrate. The CCD image sensor may be any of an interline type, a frame transfer type, and a full frame transfer type.

The lens 5 is positioned along the Y-axis direction between the positions of the light entrance portion 2 and the optical detector 4 and the position of the reflective diffraction grating 3. The lens 5 guides the light to be measured L1 incident from the light entrance portion 2 to the reflective diffraction grating 3, and forms a spectral image α of the light to be measured L1 dispersed by the reflective diffraction grating 3 in the light receiving region 40 of the optical detector 4. The lens 5 is a convex lens having a surface 5a and a convex surface 5b opposite to the surface 5a. The surface 5a faces the light entrance portion 2 and the optical detector 4. The surface 5a is a flat surface, a concave surface, or a convex surface. The convex surface 5b faces the reflective diffraction grating 3 and is a surface curved in a convex shape opposite to the surface 5a.

The analyzer 6 generates spectral data S3 of the light to be measured L1 based on data acquired from the optical detector 4. Content of analysis by the analyzer 6 will be described later. The analyzer 6 includes a storage unit that stores data acquired from the optical detector 4, an analysis result, etc. Further, the analyzer 6 may control the optical detector 4. The analyzer 6 may be, for example, a computer or a tablet terminal equipped with a processor such as a CPU (Central Processing Unit) and a storage medium such as a RAM (Random Access Memory) or a ROM (Read Only Memory). The analyzer 6 may include a microcomputer or an FPGA (Field Programmable Gate Array).

In the spectroscopic measurement device 1 configured as above, the light to be measured L1 incident from the light entrance portion 2 is incident on the surface 5a at a constant incidence angle. The light to be measured L1 incident on the surface 5a is refracted at the surface 5a in accordance with a difference between a refractive index of air and a refractive index of the lens 5, travels inside the lens 5, and exits from the convex surface 5b. The light to be measured L1 exiting from the convex surface 5b is refracted at the convex surface 5b in accordance with the difference between the refractive index of the lens 5 and the refractive index of air, and is guided to the reflective diffraction grating 3 at a downstream stage.

The light to be measured L1 dispersed by the reflective diffraction grating 3 is incident on the lens 5 again. In the lens 5, the dispersed light to be measured L1 is incident on the convex surface 5b at a constant incidence angle. The dispersed light to be measured L1 incident on the convex surface 5b is refracted at the convex surface 5b in accordance with the difference between the refractive index of air and the refractive index of the lens 5, travels inside the lens 5, and exits from the surface 5a. The dispersed light to be measured L1 exiting from the surface 5a is refracted at the surface 5a in accordance with the difference between the refractive index of the lens 5 and the refractive index of air, is imaged on the optical detector 4 at a downstream stage, and forms a spectral image α on the light receiving region 40.

Here, stray light may be generated in an optical path from the light entrance portion 2 to the optical detector 4. For example, stray light L2 may be generated due to multiple reflections of a part of the light to be measured L1 in the lens 5. For example, a part of the light to be measured L1 incident from the light entrance portion 2 or a part of the light to be measured L1 dispersed by the reflective diffraction grating 3 may be multiple-reflected between the surface 5a and the convex surface 5b, and may be emitted from the surface 5a as the stray light L2. The stray light L2 may appear as an unnatural peak in spectral data. When the distance D is increased, the optical detector 4 can prevent the stray light L2 from being incident on the optical detector 4. However, when the distance D is increased, a shift in an imaging position due to a difference in wavelength increases, resulting in a decrease in wavelength resolution. In the present embodiment, the distance D is set so that a region where the stray light L2 gathers (stray light region β) is located at a first light receiving region 41 in the light receiving region 40 of the optical detector 4.

### [Configuration of Optical Detector]

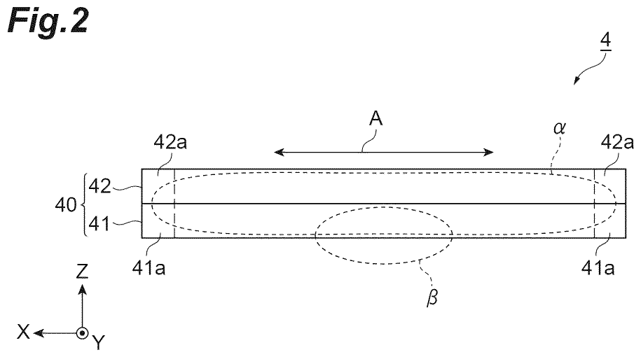

As illustrated in FIG. 2, the light receiving region 40 of the optical detector 4 is divided into the first light receiving region 41 and a second light receiving region 42. The first light receiving region 41 and the second light receiving region 42 are arranged side by side along the Z-axis direction, which is the direction perpendicular to the wavelength axis A. In the first light receiving region 41, the optical detector 4 has a plurality of first light detection channels 41a arranged side by side along the X-axis direction, which is a direction parallel to the wavelength axis A. Similarly, in the second light receiving region 42, the optical detector 4 has a plurality of second light detection channels 42a arranged side by side along the X-axis direction, which is a direction parallel to the wavelength axis A. Each of the light detection channels 42a and 42b includes a plurality of pixels arranged side by side along the Z-axis direction. In addition, the optical detector 4 receives the spectral image α at a first exposure time in the first light receiving region 41, thereby outputting first spectral data S1 of the light to be measured L1 for each of the plurality of first light detection channels 41a. Additionally, the optical detector 4 receives the spectral image α at a second exposure time in the second light receiving region 42, thereby outputting second spectral data S2 of the light to be measured L1 for each of the plurality of second light detection channels 42a. The second exposure time is longer than the first exposure time. In the spectral image α formed on the light receiving region 40, the wavelength axis A extends in the X-axis direction, and an image for each wavelength extends in the Z-axis direction. The spectral image α has a vertically symmetrical shape with a boundary between the first light receiving region 41 and the second light receiving region 42 as an axis of symmetry.

Output of the first spectral data S1 will be described in more detail. In the first light receiving region 41, charges generated and accumulated in a plurality of pixels included in each of the first light detection channels 41a are transferred to a first horizontal shift register (not illustrated). Then, the accumulated charges are added up for each of the first light detection channels 41a in the first horizontal shift register (hereinafter, this operation is referred to as “vertical transfer”). Thereafter, the charges added up for each of the first light detection channels 41a in the first horizontal shift register are sequentially read from the first horizontal shift register (hereinafter, this operation is referred to as “horizontal transfer”). Then, a voltage value according to a quantity of charges read from the first horizontal shift register is output from a first amplifier (not illustrated), and the voltage value is AD-converted by an AD converter into a digital value. In this way, the first spectral data S1 is output.

Output of the second spectral data S2 will be described in more detail. In the second light receiving region 42, charges generated and accumulated in a plurality of pixels included in each of the second light detection channels 42a are transferred to a second horizontal shift register (not illustrated). Then, the accumulated charges are added up for each of the second light detection channels 42a in the second horizontal shift register (vertical transfer). Thereafter, the charges added up for each of the second light detection channels 42a in the second horizontal shift register are sequentially read from the second horizontal shift register (horizontal transfer). Then, a voltage value according to a quantity of charges read from the second horizontal shift register is output from a second amplifier (not illustrated), and the voltage value is AD-converted by the AD converter into a digital value. In this way, the second spectral data S2 is output.

In the optical detector 4, the second exposure time in the second light receiving region 42 is longer than the first exposure time in the first light receiving region 41. The exposure time of each region can be set, for example, by an electronic shutter. The electronic shutter can be realized by using an anti-blooming gate (ABG).

The stray light region β formed by gathering of the stray light L2 is located in the first light receiving region 41. Specifically, the distance D between the light entrance portion 2 and the optical detector 4 in the Z-axis direction is set so that the stray light region β is located in the first light receiving region 41. Here, the distance D is set so that the stray light region β is not located in the second light receiving region 42. In other words, the optical detector 4 is disposed so that the stray light region β, where the stray light L2 generated in the lens 5 gathers, is located in the first light receiving region 41 and is not located in the second light receiving region 42. In addition, since the stray light L2 is generated inside the lens 5, a position of the stray light region β is adjusted by adjusting a positional relationship between the lens 5 and the optical detector 4. Therefore, in the first spectral data S1, the stray light L2 is detected in a wavelength band Δλ corresponding to the stray light region β. On the other hand, in the second spectral data S2, the stray light L2 is not detected in the wavelength band Δλ corresponding to the stray light region β. In an example of FIG. 2, the stray light region β is an ellipse having a minor axis in the Z-axis direction and a major axis in the X-axis direction, and a length of the minor axis is longer than a length of the first light receiving region 41 in the Z-axis direction. Therefore, a part of the stray light region β is located in the first light receiving region 41.

### [Method of Generating Spectral Data of Light to be Measured]

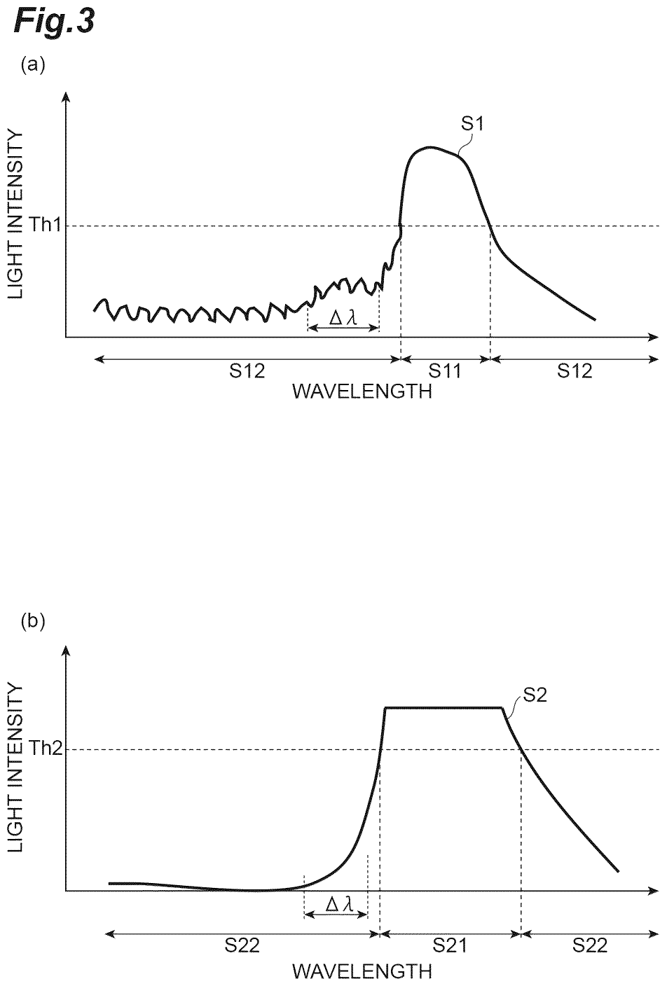

As illustrated in FIG. 3(a), the first spectral data S1 is acquired in the first light receiving region 41 in a short exposure time. The analyzer 6 can acquire light intensity in all wavelength bands without saturating each pixel in all wavelength bands. In contrast, as illustrated in FIG. 3(b), the second spectral data S2 is acquired in the second light receiving region 42 in a long exposure time. The second spectral data S2 includes a wavelength band in which each pixel is saturated. Therefore, the analyzer 6 cannot accurately acquire light intensity in the wavelength band in which each pixel is saturated. On the other hand, the first spectral data S1 has noise superimposed in a wavelength band where the light intensity is low, and has a poor S/N ratio. The second spectral data S2 can acquire highly accurate data without noise superimposed even in the wavelength band where the light intensity is low.

In the first spectral data S1, the stray light L2 is detected in the wavelength band Δλ corresponding to the stray light region β. The stray light L2 is detected as data like a protrusion (bump) in the first spectral data S1. In the first spectral data S1, the wavelength band Δλ corresponding to the stray light region β is offset from a wavelength band where light intensity is high. In other words, the wavelength band Δλ corresponding to the stray light region β is adjusted so as not to overlap with the wavelength band where light intensity is high. As an adjustment means, for example, the position of the stray light region β on the first light receiving region 41 is moved along the wavelength axis A.

In the first spectral data S1, the analyzer 6 sets a threshold Th1, which is light intensity greater than light intensity of the stray light L2. In the first spectral data S1, the analyzer 6 sets a part equal to or greater than the threshold Th1 as data S11, and sets a part below the threshold Th1 as data S12. In other words, the data S11 is data in a wavelength band not including the wavelength band Δλ corresponding to the stray light region β in the first spectral data S1. The data S12 is data in a wavelength band including the wavelength band Δλ corresponding to the stray light region β in the first spectral data S1. Therefore, data in which the stray light L2 is detected is included in the data S12. In addition, data in a wavelength band in which light intensity is low is included in data S12. Meanwhile, in the second spectral data S2, the analyzer 6 sets a threshold Th2, which is light intensity greater than the light intensity of the stray light L2. In the second spectral data S2, the analyzer 6 sets a part equal to or greater than the threshold Th2 as data S21, and sets a part below the threshold Th2 as data S22. In other words, the data S21 is data in a wavelength band not including the wavelength band Δλ corresponding to the stray light region β in the second spectral data S2. The data S22 is data in a wavelength band including the wavelength band Δλ corresponding to the stray light region β in the second spectral data S2. Here, data in the wavelength band in which each pixel is saturated is included in the data S21. Note that, in the first spectral data S1, the analyzer 6 may set a part exceeding the threshold Th1 as data S11, and set a part equal to or less than the threshold Th1 as the data S12. In addition, in the second spectral data S2, a part exceeding the threshold Th2 may be set as the data S21, and a part equal to or less than the threshold Th2 may be set as the data S22.

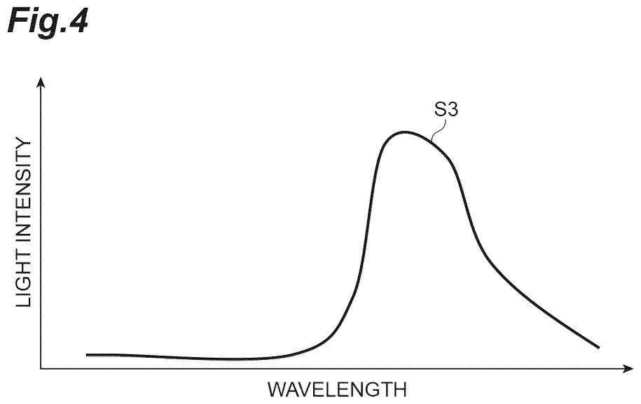

As illustrated in FIG. 4, the analyzer 6 generates third spectral data (spectral data of the light to be measured L1) S3 based on the first spectral data S1 and the second spectral data S2. Specifically, the analyzer 6 generates the third spectral data S3 by joining the data S11 and the data S22. The analyzer 6 first excludes the data S12 from the first spectral data S1. Then, the analyzer 6 cuts out the data S22 from the second spectral data and joins the data S22 to the data S11 to complement the excluded data S12 using the data S22. The analyzer 6 does not use the data S12 including the data in which the stray light L2 is detected in generating the third spectral data S3, so that the data in which the stray light L2 is detected is excluded from the third spectral data S3. In addition, the analyzer 6 does not use the data S21 in generating the third spectral data S3. Therefore, in the third spectral data S3, each pixel is not saturated in all wavelength bands, and light intensity can be acquired in all wavelength bands.

### [Actions and Effects]

In the spectroscopic measurement device 1, the light receiving region 40 of the optical detector 4 has the first light receiving region 41 and the second light receiving region 42 arranged side by side in the direction perpendicular to the wavelength axis A of the spectral image α, and the optical detector 4 is disposed so that the stray light region β, in which the stray light L2 generated in the lens 5 gathers, is located in the first light receiving region 41 and is not located in the second light receiving region 42. In this way, when compared to the case where the distance D between the light entrance portion 2 and the optical detector 4 is increased so that the stray light region β is not located in the light receiving region 40 of the optical detector 4, aberration generated by the lens 5 can be reduced, thereby suppressing a reduction in wavelength resolution in measurement of the light to be measured L1. Further, in the spectroscopic measurement device 1, the optical detector 4 outputs the first spectral data S1 of the light to be measured L1 by receiving the spectral image α in the first exposure time in the first light receiving region 41 and outputs the second spectral data S2 of the light to be measured L1 by receiving the spectral image α in the second exposure time longer than the first exposure time in the second light receiving region 42, and the analyzer 6 generates the spectral data S3 of the light to be measured L1 based on the first spectral data S1 and the second spectral data S2. In this way, by using the first spectral data S1 for a wavelength band in which light intensity is high and using the second spectral data S2 for a wavelength band in which light intensity is low while offsetting the wavelength band Δλ corresponding to the stray light region β from a wavelength band where light intensity is high in generating the spectral data S3 of the light to be measured L1, it is possible to suppress a decrease in detection accuracy in measurement of the light to be measured L1. As described above, according to the spectroscopic measurement device 1, it is possible to suppress both a decrease in wavelength resolution and a decrease in detection accuracy in measurement of the light to be measured L1.

In the spectroscopic measurement device 1, the analyzer 6 generates the spectral data S3 based on the data S11 in the wavelength band not including the wavelength band Δλ corresponding to the stray light region β in the first spectral data S1 and the data S22 in the wavelength band including the wavelength band Δλ corresponding to the stray light region β in the second spectral data S2. In the spectroscopic measurement device 1, the stray light L2 is detected in the wavelength band Δλ corresponding to the stray light region β in the first spectral data S1. On the other hand, the stray light L2 is not detected in the wavelength band Δλ corresponding to the stray light region β in the second spectral data S2. Therefore, according to the spectroscopic measurement device 1, a decrease in detection accuracy in measurement of the light to be measured L1 can be suppressed by complementing data in an excluded wavelength band using the data S22 in the second spectral data S2 while eliminating an influence of the stray light L2 from the first spectral data S1.

In the spectroscopic measurement device 1, the optical detector 4 is offset to one side (the side where the dispersed light to be measured L1 is incident) in the direction perpendicular to the wavelength axis A with respect to the light entrance portion 2. In this way, it is possible to easily and reliably realize arrangement of the optical detector 4 for positioning the stray light region β in the first light receiving region 41.

In the spectroscopic measurement device 1, for example, the stray light L2 is generated in the lens 5 by multiple reflections of a part of the light to be measured L1 inside the lens 5. The dominant cause of appearance of the stray light region β is multiple reflections of a part of the light to be measured L1 inside the lens 5. In this way, it is possible to further suppress a decrease in detection accuracy in measurement of the light to be measured L1 by eliminating the influence of the stray light region β.

In the spectroscopic measurement device 1, the lens 5 is a convex lens having the surface 5a facing the light entrance portion 2 and the optical detector 4, and the convex surface 5b facing the reflective diffraction grating 3. In this way, it is possible to guide the light to be measured L1 incident from the light entrance portion 2 to the reflective diffraction grating 3, and to form the spectral image α of the light to be measured L1 dispersed by the reflective diffraction grating 3 in the light receiving region 40 of the optical detector 4.

### Modified Example

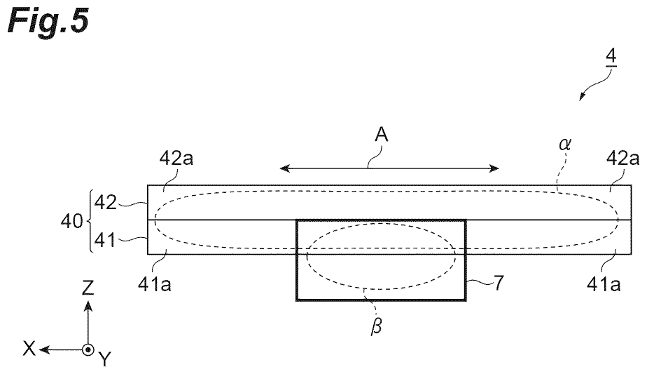

The disclosure is not limited to the above-mentioned embodiment. As illustrated in FIG. 5, a mask member 7 may be disposed between the lens 5 and the optical detector 4. In this case, the optical detector 4 is disposed so that the stray light region β is located in the first light receiving region 41 and is not located in the second light receiving region 42. However, since the mask member 7 masks incidence of the stray light L2 on the first light receiving region 41, the stray light region β is not directly located in the first light receiving region 41. By disposing the mask member 7, the stray light L2 is not detected in the first spectral data S1. In this way, it is possible to eliminate the influence of the stray light L2 by blocking incidence of the stray light L2 on the optical detector 4. Therefore, it is possible to further suppress the decrease in detection accuracy in measurement of the light to be measured L1. The mask member 7 is, for example, a light-shielding film. It is sufficient that a size of an outer edge of the mask member 7 when viewed from the Y-axis direction is larger than a size of an outer edge of the stray light region β. A shape of the mask member 7 when viewed from the Y-axis direction is not limited to a rectangular shape, and may be a circular shape, an elliptical shape, or a triangular shape.

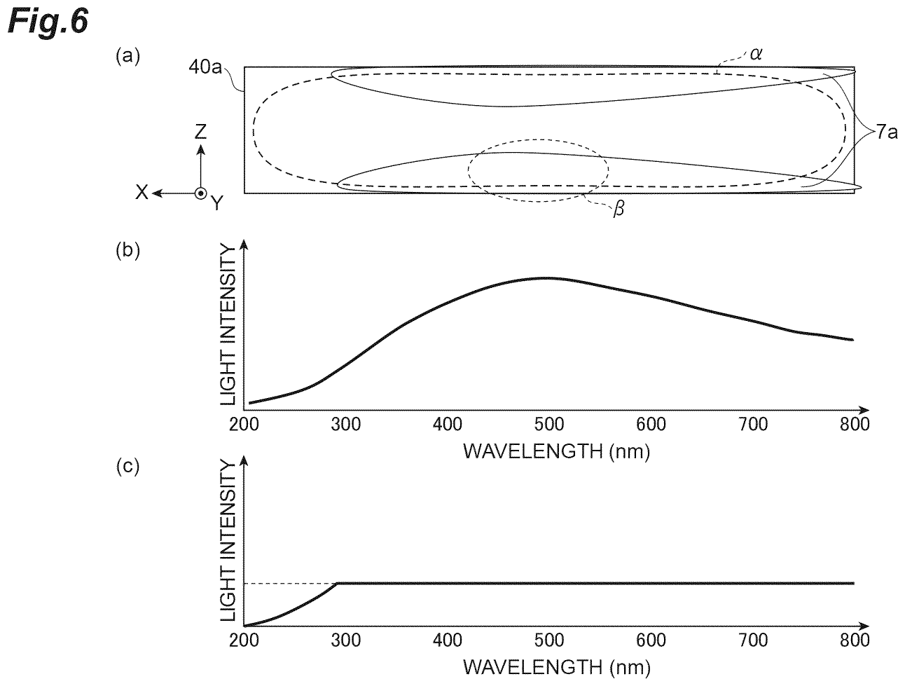

As illustrated in FIG. 6, the mask member 7 may be used to correct spectral sensitivity of the optical detector 4 in addition to masking the stray light L2. FIG. 6(a) is a diagram in which a mask member 7a used to correct spectral sensitivity is disposed on a light receiving region 40a not divided into the first light receiving region 41 and the second light receiving region 42. The mask member 7a is designed based on characteristics of spectral data of FIG. 6(b). The spectral data illustrated in FIG. 6(b) is data of the light to be measured L1 generated by the analyzer 6 when the mask member 7a is not disposed in the light receiving region 40a. The spectral data of FIG. 6(b) is data in which light intensity is high in a central wavelength band (near 500 nm) of the light to be measured L1 and is low in a low wavelength band (near 200 nm to 300 nm) and a high wavelength band (near 700 nm to 800 nm). The design concept of the mask member 7a is specifically as follows. In the low wavelength band (near 200 nm to 300 nm), the mask member 7a is designed not to be disposed. An area of the mask member 7a is designed to gradually increase from a wavelength band of 300 nm onwards, and the area of the mask member 7a is designed to be the largest in the central wavelength band (near 500 nm). In addition, in the high wavelength band (near 700 nm to 800 nm), the area of the mask member 7a is designed to gradually decrease from the central wavelength band (near 500 nm). In addition, the mask member 7a is designed to match the position of the stray light region β.

FIG. 6(c) is spectral data of the light to be measured L1 generated by the analyzer 6 when the mask member 7a is disposed in the light receiving region 40a. The spectral data of FIG. 6(c) exhibits the same characteristics as those of the spectral data of FIG. 6(b) in the low wavelength band (near 200 nm to 300 nm). However, in a wavelength band after 300 nm, light intensity becomes a constant value. A reason therefor is that spectral sensitivity is corrected by the mask member 7a in FIG. 6(a). Furthermore, the mask member 7a masks incidence of the stray light L2 on the light receiving region 40a. As a result, the stray light L2 is not detected in the spectral data after sensitivity correction. Therefore, the influence of the stray light L2 can be eliminated by blocking incidence of the stray light L2 on the optical detector 4. Note that, in FIG. 6(a), the mask member 7a is divided into two parts. However, as long as the above-mentioned design concept is followed, the mask member 7a may have an integral shape or may be divided into three or more parts.

The optical detector 4 may be a CMOS image sensor. In the case of the CMOS image sensor, each pixel has a photodiode (photoelectric conversion element) and an amplifier. The photodiode accumulates electrons (photoelectrons) generated by input of photons as charges. The amplifier converts the charges accumulated in the photodiode into voltages and amplifies the converted voltages. The amplified voltages are transferred to the AD converter for each of the first light detection channels 41a and each of the second light detection channels 42a by switching a selection switch of each pixel. The amplified voltages are converted into digital values by the AD converter and output as the first spectral data S1 and the second spectral data S2.

The optical detector 4 may be a CCD-CMOS image sensor. In the case of the CCD-CMOS image sensor, the optical detector 4 has a plurality of signal readout circuits corresponding to each of the first light detection channels 41a and each of the second light detection channels 42a. Each of the signal readout circuits has a transistor and a bonding pad for signal output. A voltage according to a quantity of charges transferred from each of the first light detection channels 41a and each of the second light detection channels 42a is applied to a control terminal of the transistor. Then, a current having the magnitude according to the corresponding voltage level is output from the output terminal of the transistor and extracted via the bonding pad for signal output. The extracted current is converted into a digital value by the AD converter and output as the first spectral data S1 and the second spectral data S2.

The stray light L2 is not limited to being generated in the lens 5, and may be generated in an optical path from the light entrance portion 2 to the optical detector 4. For example, the stray light L2 may be generated between the light entrance portion 2 and the lens 5, between the lens 5 and the reflective diffraction grating 3, or between the lens 5 and the optical detector 4.

### REFERENCE SIGNS LIST

1: spectroscopic measurement device, 2: light entrance portion, 3: reflective diffraction grating, 4: optical detector, 5: lens, 5a: surface, 5b: convex surface, 6: analyzer, 7, 7a: mask member, 40: light receiving region, 41: first light receiving region, 41a: first light detection channel, 42: second light receiving region, 42a: second light detection channel, A: wavelength axis, L1: light to be measured, L2: stray light, S1: first spectral data, S2: second spectral data, S3: spectral data, α: spectral image, β: stray light region.

1: A spectroscopic measurement device comprising:
a light entrance portion allowing light to be measured to be incident thereon;
a reflective diffraction grating configured to disperse the light to be measured incident from the light entrance portion;
an optical detector configured to detect the light to be measured dispersed by the reflective diffraction grating;
a lens configured to guide the light to be measured incident from the light entrance portion to the reflective diffraction grating and to form a spectral image of the light to be measured dispersed by the reflective diffraction grating on a light receiving region of the optical detector; and
an analyzer configured to generate spectral data of the light to be measured, wherein:
the light receiving region includes:
a first light receiving region including a plurality of first light detection channels arranged in a direction parallel to a wavelength axis of the spectral image; and
a second light receiving region arranged side by side with the first light receiving region in a direction perpendicular to the wavelength axis, and including a plurality of second light detection channels arranged in the direction parallel to the wavelength axis,
the optical detector outputs first spectral data of the light to be measured by receiving the spectral image in a first exposure time in the first light receiving region, and outputs second spectral data of the light to be measured by receiving the spectral image in a second exposure time longer than the first exposure time in the second light receiving region,
the analyzer generates the spectral data based on the first spectral data and the second spectral data output from the optical detector, and
the optical detector is disposed so that a stray light region, in which stray light generated in an optical path from the light entrance portion to the optical detector gathers, is located in the first light receiving region.

2: The spectroscopic measurement device according to claim 1, wherein the analyzer generates the spectral data based on data in a wavelength band not including a wavelength band corresponding to the stray light region in the first spectral data and data in a wavelength band including the wavelength band corresponding to the stray light region in the second spectral data.

3: The spectroscopic measurement device according to claim 1, wherein the optical detector is offset to one side in the direction perpendicular to the wavelength axis with respect to the light entrance portion.

4: The spectroscopic measurement device according to claim 1, wherein the stray light is generated by multiple reflections of a part of the light to be measured inside the lens.

5: The spectroscopic measurement device according to claim 1, further comprising a mask member disposed between the lens and the optical detector and configured to block the stray light.

6: The spectroscopic measurement device according to claim 1, wherein the lens is a convex lens having a surface facing the light entrance portion and the optical detector, and a convex surface facing the reflective diffraction grating.
